(19) United States
(12) Patent Application Publication
(10) Pub. No.: US 2016/0254547 A1
(43) Pub. Date: Sep. 1, 2016

(54) UNDERLAYER FOR CELL ELECTRODES, CURRENT COLLECTOR USING THE SAME, ELECTRODE, AND LITHIUM ION SECONDARY CELL

(71) Applicant: TOPPAN PRINTING CO., LTD., Tokyo (JP)

(72) Inventors: Yoshihito MATSUI, Tokyo (JP); Noriyuki ITO, Tokyo (JP)

(73) Assignee: TOPPAN PRINTING CO., LTD., Tokyo (JP)

(21) Appl. No.: 15/150,923

(22) Filed: May 10, 2016

Related U.S. Application Data
(63) Continuation of application No. PCT/JP2014/005684, filed on Nov. 12, 2014.

(30) Foreign Application Priority Data
Nov. 13, 2013 (JP) 2013-235144

(51) Int. Cl. H01M 4/66; H01M 4/131; H01M 4/505; H01M 10/0569; H01M 2/16; H01M 4/38; H01M 10/0568; H01M 4/62; H01M 10/0585

(52) U.S. Cl. CPC H01M 4/668; H01M 4/625; H01M 4/661; H01M 4/131; H01M 4/505; H01M 4/623; H01M 4/667; H01M 4/663; H01M 10/0585; H01M 2/1653; H01M 4/382; H01M 10/0568; H01M 10/0569; H01M 2004/028

(57) ABSTRACT

An underlayer for better suppressing the lowering of adhesion between a current collector and an electrode layer. The underlayer is provided between a current collector and an electrode layer of a secondary cell and comprises a conductive material, and an amorphous polyester resin having a bisphenol A skeleton in the main chain, which serves as a binder for binding the conductive material together. Further disclosed are an underlayer-attached current collector wherein the underlayer is formed on a current collector, an electrode wherein an electrode is further overcoated on this current collector, and a lithium ion secondary cell provided with this electrode.

### CROSS-REFERENCE TO RELATED PATENT APPLICATIONS

This application is a continuation application filed under 35 U.S.C. §111(a) claiming the benefit under 35 U.S.C. §§120 and 365(c) of PCT International Application No. PCT/JP2014/005684 filed on Nov. 12, 2014, which is based upon and claims the benefit of priority of Japanese Application No. 2013-235144, filed on Nov. 13, 2013, the entire contents of them all are hereby incorporated by reference.

### TECHNICAL FIELD

This invention relates to an underlayer for lithium ion secondary cells and also to an electrode having this underlayer. More particularly, the invention relates to an underlayer interposed between a current collector and an electrode layer, an underlayer-attached current collector wherein the underlayer is formed on a current collector, an electrode wherein an electrode layer is further overcoated, and a lithium ion secondary cell using the electrode.

### BACKGROUND

Components for electrodes of lithium ion secondary cells have been used in cells (including capacitors) employed, for example, in electric automobiles, fuel-cell automobiles, hybrid automobiles, electricity storage systems for home use, electric tools, electric trains, compact portables and the like. Especially, in recent years, lithium ion secondary cells have been remarkably developed as mounted on automobiles.

The constituent components of lithium ion secondary cells can be broadly classified into a positive electrode, a negative electrode, a separator and an electrolytic solution. Among them, the electrodes are constituted of materials such as a current collector, an active substance, a binder and a conductive aid, which greatly influence the performance of a cell as a whole.

The electrode is fabricated by coating, onto a current collector such as of a metal foil, a slurry of materials including an active substance, a binder, a conductive aid and the like dispersed and mixed in a solvent (including one having a function as a dispersion medium) by means of a coating machine, followed by drying in an oven usually incorporated as a part of the coating machine and rewinding. If necessary, slitting or pressing may be subsequently performed.

However, when the electrode layer formed on the current collector such as of a metal foil is subjected to repeated charge and discharge cycles, adhesion at the interface between the current collector and the electrode layer can deteriorate thereby resulting in an increased resistance that lowers discharge capacity. Accordingly, the charge and discharge cycle life may not be satisfactory. Additionally, there is a problem in that the fine powder of the electrode dropped off from the current collector causes short-circuiting.

These effects are considered to occur for the reason that the doping and de-doping of lithium ions associated with charge and discharge cycles entails repeated expansion and shrinkage of an active substance, so that a shear force is locally generated at the interface between the current collector and the electrode layer. This shear force causes the interfacial adhesion between the current collector and the electrode layer to be deteriorated and eventually causes the current collector and the electrode layer to be peeled off.

In PTL 1, there is disclosed an electrode layer, characterized by comprising carbon black, a polymer compound containing a fluorine-based polymer compound, and a thermally curable crosslinking agent and being formed on a current collector through a thermally-cured underlayer. In PTL 2, an electrode layer is disclosed, which is characterized by comprising carbon black and a polymer compound capable of being cured by exposure to radiation and by being formed on a current collector through an underlayer having subjected to radiation-curing treatment. However, with the methods of PTL 1 and 2, because a curing agent is used for the formation of the underlayer, a curing step is needed with the attendant problem that productivity lowers.

### CITATION LIST

### Patent Literature

PTL 1: JP-A-H07-201362

PTL 2: JP-A-H07-201363

### SUMMARY OF THE INVENTION

### Technical Problem

The present invention has been made under such circumstances as stated above and has for its object the provision of an underlayer capable of better suppressing the adhesion between a current collector and an electrode layer from lowering, an underlayer-attached current collector wherein the underlayer is formed on a current collector, an electrode wherein an electrode layer is further overcoated on the current collector, and a lithium ion secondary cell provided with the electrode.

### Solution to Problem

The present inventors have found that the above object can be better achieved without use of a curing agent when an amorphous polyester resin having a bisphenol A skeleton in the main chain is used as a binder contained in an underlayer.

More particularly, according to one aspect of the invention, there is provided an underlayer provided between a current collector and an electrode layer of an electrode of a secondary cell, the underlayer comprising a conductive material and an amorphous polyester resin having a bisphenol A skeleton in its main chain as a binder for binding the conductive material together.

The conductive material may be a carbon material.

The carbon material may be acetylene black.

The number average molecular weight of the amorphous polyester having a bisphenol A skeleton in the main chain may be within a range of from 14000 to 22000, inclusive.

In another aspect of the invention, the above underlayer is formed on a current collector to provide an underlayer-attached current collector.

The current collector may be made of an aluminum foil.

A further aspect of the invention is directed to an electrode wherein an electrode layer is further stacked on the underlayer of the underlayer-attached current collector.

The electrode layer may contain a positive electrode active substance.

A still further aspect of the invention is directed to a lithium ion secondary cell provided with the above electrode.

### Intended Effect of Invention

According to the invention, there can be provided, by processes suited for mass production, an underlayer capable of better suppressing the lowering of adhesion between a current collector and an electrode layer, an underlayer-attached current collector wherein the underlayer is formed on a current collector, an electrode obtained by further overcoating an electrode layer on the current collector, and a lithium ion secondary cell provided with the electrode.

### BRIEF DESCRIPTION OF THE DRAWINGS

FIG. 1 is a graph showing the results of a charge and discharge cycle evaluation test.

### DESCRIPTION OF THE REPRESENTATIVE EMBODIMENTS

An embodiment of the invention is now described in detail. The present embodiment is described in detail for better understanding of the principle of the invention, and should not be construed to limit the present invention unless otherwise specifically provided. Instead the embodiment described below is representative of the disclosed invention.

An underlayer according to this embodiment is one that is provided between a current collector and an active substance layer of a constituent electrode of a lithium ion secondary cell, characterized in that the underlayer is formed of a binder for binding a conductive material together and the binder is made of an amorphous polyester resin having a bisphenol A skeleton in the main chain. The bisphenol A skeleton means a polymer structure wherein the molecular structure derived from bisphenol A is contained in the constituent units (repeating structure) of the main chain of the polymer. The underlayer is described below.

### (Binder)

The binder related to this embodiment is initially described. In general, although the binders used include chemically and physically stable materials such as polyvinylidene fluoride, polytetrafluoroethylene, EPDM (ethylene-propylene-diene rubber), SBR (styrene/butadiene rubber), nitrile rubber, fluorine rubber and the like, it is necessary to use those materials that are dissolved in solvents for slurry, but are not dissolved in or swollen with electrolytic solutions of cells. Accordingly, an amorphous polyester resin having a bisphenol A skeleton in the main chain is used as a binder related to the present embodiment. Since carbonate esters, such as dimethyl carbonate, diethyl carbonate, ethylene carbonate, propylene carbonate, butylene carbonate and the like, are frequently used as a solvent of an electrolytic solution, the binder should satisfy the requirements of not being dissolved in or swollen with these solvents and mixtures thereof. As a result of our experiments, it has been found that amorphous polyester resins having no bisphenol A skeleton in the main chain are mostly dissolved in or swollen with carbonate esters, whereas amorphous polyester resins having a bisphenol A skeleton in the main chain are better resistant to carbonate esters. In view of this, when using an amorphous polyester resin having a bisphenol A skeleton in the main chain, the pronounced effects of the invention are obtained such that an electrode having excellent cycle characteristics are obtained in the case where an ordinary carbon material is used as a conductive material described hereinafter. The number average molecular weight of the amorphous polyester resin having a bisphenol A skeleton in the main chain is preferably within a range of 14000 to 22000, inclusive. If the number average molecular weight of the amorphous polyester resin having a bisphenol A skeleton in the main chain is smaller than 14000, immersion in carbonate esters may result in swelling. On the other hand, when the number average molecular weight of the amorphous polyester resin having a bisphenol A skeleton in the main chain is larger than 22000, the resin is less likely to be dissolved in the solvent of a slurry.

### (Conductive Material)

Next, conductive materials are described. As a conductive material, carbon materials are preferably used including ketjen black, acetylene black, carbon black, graphite, carbon nanotubes, amorphous carbon and the like. Of these, acetylene black is most preferred because it has such a structure that carbon particles having a very small size of 50 nm to 200 nm are arranged in chains and has thus an excellent shape for forming conduction paths. It will be noted that the term “conductive material” used herein has the same meaning as indicated by “conductive agent”

### (Preparation of an Underlayer Slurry)

Next, a method of preparing an underlayer slurry is described. The underlayer slurry can be obtained by mixing a binder, a conductive material and a solvent. The solvent also has a function as a dispersion medium for dispersing a conductive agent. The manner of mixing is not critical, for which ordinary agitation mixers of rotary and planetary types can be used. The solvent should be selected from those that are capable of dissolving binders. In the case where an amorphous polyester resin having a bisphenol A skeleton in the main chain is used as a binder related to this embodiment, the solvent used is preferably toluene. In this connection, however, the use of a mixture of toluene and MEK (methyl ethyl ketone) is more preferred from the standpoint of the drying speed during coating.

Initially, a binder is introduced into such a solvent as indicated above and well dissolved by means of an agitation mixer. Next, a conductive material is introduced and further mixed under agitation. Although not specifically limited, the agitation mixing is generally carried out for several tens of minutes to several hours in order that the conductive material should be completely uniformly dispersed, thereby obtaining an underlayer slurry.

### (Formation of an Underlayer)

Next, the manner of forming the underlayer is illustrated. The underlayer slurry obtained above is coated onto a current collector, and the coated film is dried to form an underlayer. In the practical step, the underlayer is obtained in the form of a underlayer-attached current collector having the underlayer on its surface. The manner of coating the underlayer slurry is not specifically limited. For the coating of the underlayer slurry, there can be used a roll coater, an air knife coater, a blade coater, a rod coater, a reverse coater, a bar coater, a comma coater, a dip squeeze coater, a die coater, a gravure coater, a micro-gravure coater, a silk screen coater and the like. Especially, a die coating method using a die coater is preferred so as to uniformly coat and form the underlayer.

The drying of the coated film is not specifically limited. For the drying of the coated film, hot air, far infrared light, a microwave and the like may be utilized, aside from natural drying. However, the usual practice is to dry the film in an oven integrally incorporated at the rear of a coating machine (coater). After the drying, the coated current collector is taken up in the form of a roll at the rewinding unit of the coater. The operations of from unwinding to rewinding are preferably carried out continuously in sequence.

The underlayer-attached current collector related to this embodiment is such that the underlayer is formed on the current collector. The current collector is now described.

### (Current Collector)

The current collector is not specifically limited in type, for which a current collector made of a known material such as aluminum, stainless steel, nickel-plated steel, copper or the like can be used. In particular, it is preferred to use an aluminum foil so as to form an underlayer of a positive electrode.

The electrode of the present embodiment is such that an electrode layer is further formed on the underlayer of the underlayer-attached current collector. The electrode is then illustrated.

### (Electrode Active Substance)

Initially, an electrode active substance is described. As an active substance contained in the electrode layer to be overcoated onto the underlayer, there can be used arbitrary active substances ordinarily employed as active substances for positive and negative electrodes. Because the effect of the underlayer of this embodiment is remarkably developed when used for a positive electrode, the underlayer should preferably be used for a positive electrode. Where the underlayer of the embodiment is used for a positive electrode, the positive electrode active substances used include lithium transition metal composite oxides, which are capable of absorbing and releasing lithium ions and include, for example, lithium cobalt oxide, lithium manganese oxide, lithium nickel oxide and composite oxides (mixtures) thereof, and lithium iron phosphate. Of these, lithium manganese oxide is most preferred in view of electrode performance and costs.

(Electrode Binder)

Next, an electrode binder is illustrated. It is preferred to use, as an electrode binder, chemically and physically stable materials such as polyvinylidene fluoride, polytetrafluoroethylene, EPDM, SBR, NBR, fluorine rubber and the like. Of these, polyvinylidene fluoride is more preferred in the case where an active substance for positive electrode is used. Since polyvinylidene fluoride is soluble in N-methyl-2-pyrrolidone, its use in the form of a binder solution is possible, which is convenient for preparing an electrode slurry.

### (Electrode Conductive Aid)

Next, an electrode conductive aid is described. For the electrode conductive aid, there can be used carbon materials such as carbon black, natural graphite, artificial graphite, amorphous carbon and the like, and also metal oxides such as titanium oxide, ruthenium oxide and the like, and metal fibers. Of these, carbon black is preferred because of its structure construction. Especially, some types of carbon black including furnace black, ketjen black, acetylene black and the like are more preferred. It will be noted that carbon black may be used as a mixture with other type of conductive agent, e.g. vapor grown carbon fibers (VGCF).

### (Electrode Slurry)

Next, an electrode slurry is described. As stated above, an electrode slurry can be obtained by adding an electrode active substance, an electrode binder and an electrode conductive aid to a solvent and mixing together. The solvent has a function as a dispersion medium for dispersing the conductive agent. The mixing ratios of these ingredients can be appropriately determined depending on the viscosity of the slurry, the strength of the electrode layer and the adhesion force with the current collector required, and the necessitated cell characteristics. For instance, if polyvinylidene fluoride is used as an electrode binder, N-methyl-2-pyrrolidone is most suited as a solvent.

### (Fabrication of an Electrode Having an Underlayer)

The method of fabricating an electrode is described. The electrode slurry is coated onto the underlayer of the above-stated underlayer-attached current collector, and the coated film is dried to obtain an electrode having the underlayer. The coating and drying procedures of the electrode slurry are not specifically limited, and any of those exemplified with respect to the formation method of the underlayer may be adopted.

The lithium ion secondary cell related to the present embodiment makes use of the electrode having the underlayer. The lithium ion secondary cell is described below.

### (Lithium Ion Secondary Cell)

Initially, a lithium ion secondary cell is described. The lithium ion secondary cell of the present embodiment makes use of the above-described “electrode having the underlayer” as either one of the positive and negative electrodes and can be obtained by combining a counter electrode, a separator and an electrolytic solution. The “electrode having the underlayer” and the counter are facing each other through the separator, and the electrolytic solution is impregnated between the electrodes including the separator thereby enabling the cell function to be developed. For a package, there can be used a coin-shaped case made of an aluminum laminate film or a stainless steel.

### (Counter Electrode)

Next, a counter electrode is described. The counter electrode is one that makes a pair of facing electrodes along with the “electrode having the underlayer”, and is chosen as having opposite polarity. If the counter electrode is used as a negative electrode, the active substance used for the negative electrode is a compound capable of absorbing and releasing lithium ions, such as a carbon material including graphite, coke or the like. These may be used singly or in combination of a plurality thereof.

On the other hand, if the counter electrode is used as a positive electrode, the active substance for the positive electrode includes a lithium transition metal composite oxide capable of releasing lithium ions. Examples include lithium cobalt oxide, lithium manganese oxide, lithium nickel oxide and composite oxides and mixtures thereof, lithium iron phosphate, and the like.

### (Electrolytic Solution)

Next, an electrolytic solution is described, but is not necessarily limited to the following. The solvents of the electrolytic solution used for a non-aqueous electrolyte secondary cell include low-viscosity chain carbonic acid esters such as dimethyl carbonate, diethyl carbonate and the like, cyclic carbonic acid esters of high dielectric constant such as ethylene carbonate, propylene carbonate, butylene carbonate and the like, γ-butyrolactone, 1,2-dimethoxyethane, tetrahydrofuran, 2-methyltetrahydrofuran, 1,3-dioxorane, methyl acetate, methyl propionate, vinylene carbonate, dimethylformamide, sulfolane, and mixtures thereof.

The electrolytes contained in the electrolytic solution are not specifically limited. Examples of the electrolyte contained in the electrolytic solution include LiClO₄, LiBF₄, LiAsF₆, LiPF₆, LiCF₄SO₃, LiN(CF₃SO₂)₂, LiI, LiAlCl₄, and their mixtures of two or more. Preferably, a lithium salt chosen from LiBF₄, LiPF₆ and a mixture thereof is used.

### (Separator)

Next, the separator is described. As a separator for preventing the contact between the positive and negative electrodes, mention is made of a microporous membrane and nonwoven fabric made of a polyolefin such as polyethylene, polypropylene or the like and also of an aromatic polyamide resin, and a porous resin coat containing inorganic ceramic powder.

### (Evaluation)

Next, the evaluation method of a lithium ion secondary cell is described. The effect of the underlayer related to this embodiment can be measured by conducting a charge and discharge cycle test wherein a lithium ion secondary cell is actually assembled. Although how to make a lithium ion secondary cell is not described in detail herein, a coin cell type is usually convenient because of its ease in assembling and is thus often used.

Examples of the invention are described in detail.

### Example 1

### Preparation of an Underlayer Slurry

623 g of a pellet-shaped amorphous polyester resin having a bisphenol A skeleton in the main chain (with a number average molecular weight of 22000, commercial name: Vylon 290 manufactured by Toyobo Co., Ltd., wherein Vylon is a registered trade name) was dissolved, as an underlayer binder, in 1455 g of a mixed solvent having a ratio by weight of MEK:toluene=1:4. After complete dissolution, 267 g of acetylene black was charged, followed by mixing under agitation for 1 hour. Thereafter, a dilution solvent, mixed at a ratio by weight of MEK:toluene=1:1, was added so as to adjust its viscosity thereby obtaining an underlayer slurry.

### (Formation of an Underlayer)

The underlayer slurry obtained above was coated onto a 20 μm thick aluminum foil by gravure coating, and the coated film was dried to obtain an underlayer formed on the aluminum foil (i.e. an underlayer-attached current collector). The thickness of the underlayer was 4 μm.

### (Making of an Electrode)

A positive electrode slurry (using N-methyl-2-pyrrolidone as a solvent) containing, as solid components, 100 parts by weight of lithium manganese oxide provided as a positive electrode active substance, 5 parts by weight of acetylene black as a conductive aid and 4 parts by weight of PVdF (polyvinylidene fluoride) as an electrode binder was coated, by die coating, onto the underlayer of the underlayer-attached aluminum foil obtained above, and the coated film was dried to form an electrode layer on the underlayer. On this occasion, the thickness of the electrode layer was at 85 μm. The thus obtained laminate of the electrode layer/underlayer/aluminum foil was used as a positive electrode.

The thus obtained positive electrode was punched into a 13.5 mmφ piece and pressed. The thickness of the electrode sheet after the pressing was at 79 μm.

### (Fabrication of a Cell (Coin Half-Cell))

The electrode sheet obtained above was provided as a positive electrode and was disposed in face-to-face relation with a metallic lithium negative electrode through a separator (a flat polyolefin membrane) to assemble a coin cell. The thus assembled coil cell was charged therein with an electrolytic solution wherein LiPF₆ was dissolved in a solvent mixed at a ratio by volume of EC (ethylene carbonate):DEC (diethyl carbonate)=3:7 at a concentration of 1 mol/L to provide a coin half-cell.

### (Charge and Discharge Cycle Evaluation Method)

The coin half-cell fabricated above was disposed in a charge and discharge evaluation device, followed by a cycle test using a charge and discharge rate of one charge cycle and one discharge cycle. The finished voltage was at 4.25 V at the charge side and at 3.00 V at the discharge side. One cycle used herein means a current value, at which a cell capacity was charged or discharged in one hour.

### Example 2

In the same manner as in Example 1 except that the underlayer binder used was a flaky amorphous polyester resin having a bisphenol A skeleton in the main chain (with a number average molecular weight of 14000, commercial name: Vylon 296 manufacture by Toyobo Co., Ltd.), procedures of from the preparation of the underlayer slurry to the evaluation test of the charge and discharge cycles were carried out.

Comparative examples are described below.

### Comparative Example 1

### Making of an Electrode

A positive electrode slurry (using N-methyl-2-pyrrolidone as a solvent) containing, as solid components, 100 parts by weight of lithium manganese oxide used as a positive electrode active substance, 5 parts by weight of acetylene black used as a conductive aid, and 4 parts by weight of PVdF serving as an electrode binder was coated onto a 20 μm thick aluminum foil having no underlayer thereon by die coating, and the coated film was dried to obtain an electrode layer. The thickness of the electrode layer was 90 μm. The thus obtained laminate of the electrode layer/aluminum foil was used as a positive electrode.

The positive electrode obtained above was punched into a 13.5 mmφ piece and pressed. The electrode sheet after the pressing had a thickness of 78 μm.

Thereafter, procedures of from the fabrication of a cell to the charge discharge cycle evaluation test were conducted in the same manner as in Example 1.

### Comparative Example 2

### Making of an Electrode

A positive slurry (using N-methyl-2-pyrrolidone as a solvent) containing, as solid components, 100 parts by weight of lithium manganese oxide used as a positive electrode active substance, 5 parts by weight of acetylene black as a conductive aid and 4 parts by weight of PVdF as an electrode binder was coated, by die coating, onto a 20 μm thick commercially available carbon coated aluminum foil, which was formed with a carbon underlayer without containing, as an underlayer binder, a flaky amorphous polyester resin having a bisphenol A skeleton in the main chain, and the coated film was dried to obtain an electrode layer. The thickness of the electrode layer was 88 μm. The thus obtained laminate of the electrode layer/aluminum foil was used as a positive electrode.

The positive electrode obtained above was punched into 13.5 mmφ piece and pressed. The electrode sheet after the pressing had a thickness of 79 μm.

Thereafter, procedures of from the fabrication of a cell to the charge and discharge cycle evaluation test were carried out in the same manner as in Example 1.

### Comparative Example 3

When an amorphous polyester resin having no bisphenol A skeleton in the main chain (with a number average molecular weight of 19000, commercial name: Vylon 245, manufactured by Toyobo Co., Ltd.) was immersed in a mixed solvent (EC:DEC=3:7) used for an electrolytic solution, its swelling was confirmed. Therefore, no subsequent evaluation was made.

### Comparative Example 4

When an amorphous polyester resin having a bisphenol A skeleton in the main chain (with a number average molecular weight of 11000, commercial name: Vylon GK780, manufactured by Toyobo Co., Ltd.) was immersed in a mixed solvent (EC:DEC=3:7) used for an electrolytic solution, its swelling was confirmed. Therefore, no subsequent evaluation was made.

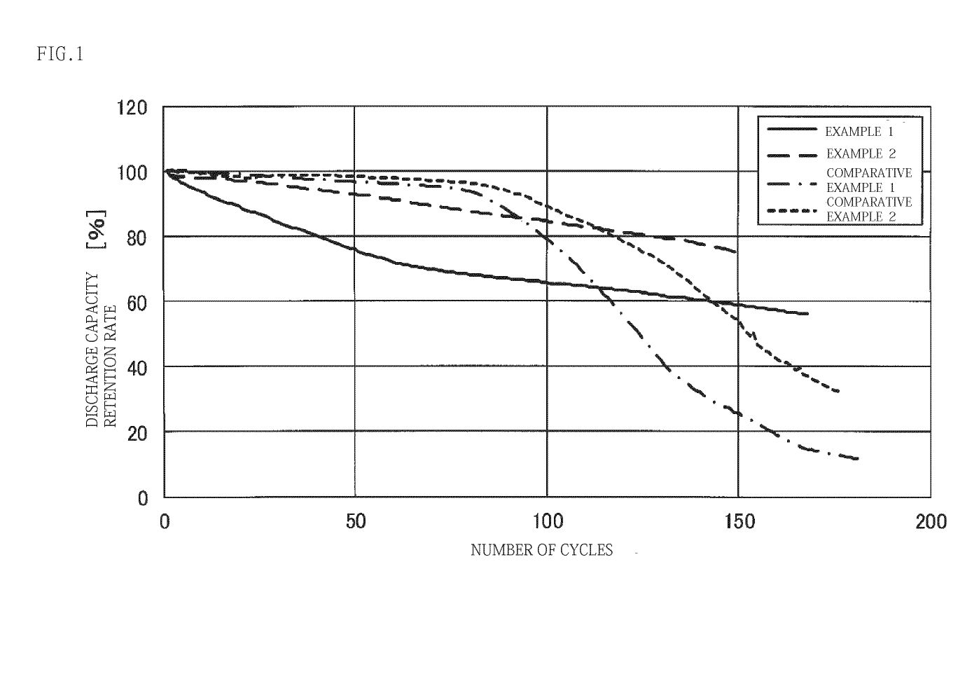

FIG. 1 is a graph showing the results of the charge and discharge cycle evaluation test carried out in Examples 1, 2 and Comparative Examples 1, 2. FIG. 1 reveals that when compared with Comparative Examples 1, 2 making use of the aluminum foil having no underlayer formed thereon and the commercially available carbon coated aluminum foil, Examples 1, 2 are more excellent in the cycle characteristics (life characteristics). Especially, it was confirmed that the initial performance was slightly inferior to, but the sustainability of the performance was more excellent with respect to the long-term life.

From the above results, it was found that the amorphous polyester resin, which was not dissolved in or swollen with a mixed solvent used for an electrolytic solution, was an amorphous polyester resin having a bisphenol A skeleton, preferably with a number average molecular weight being from not less than 14000 to not larger than 22000.

### INDUSTRIAL APPLICABILITY

The present invention is useful for lithium ion secondary cells wherein charge and discharge are repeated.

What is claimed is:

1. An underlayer is provided between a current collector and an electrode layer of a secondary cell, comprising:
a conductive agent, and
an amorphous polyester resin that acts as a binder for binding the conductive agent together and having a bisphenol A skeleton in the main chain.

2. The underlayer of claim 1, wherein the conductive agent is made of a carbon material.

3. The underlayer of claim 2, wherein the carbon material is made of acetylene black.

4. The underlayer of claim 1, wherein the amorphous polyester resin having a bisphenol A skeleton in the main chain has a number molecular weight of not less than 14000 to not larger than 22000.

5. An underlayer-attached current collector comprising the underlayer of claim 1 that is formed on a current collector.

6. The underlayer-attached current collector of claim 5, wherein the current collector is made of an aluminum foil.

7. An electrode comprising an electrode layer stacked on the underlayer of the underlayer-attached current collector of claim 5.

8. The electrode of claim 7, wherein the electrode layer comprises an active substance for positive electrode.

9. A lithium ion secondary cell comprising the electrode of claim 7.
